(19) United States
(12) Patent Application Publication
(10) Pub. No.: US 2020/0026699 A1
(43) Pub. Date: Jan. 23, 2020

(54) Highly Performant Decentralized Public Ledger with Hybrid Consensus

(71) Applicant: True Blockchain Technology Ltd., Dover, DE (US)

(72) Inventors: Jiannan Zhang, Beijing (CN); Yang Liu, Beijing (CN); Han Zhang, Sydney (AU)

(21) Appl. No.: 16/517,479

(22) Filed: Jul. 19, 2019

Related U.S. Application Data
(60) Provisional application No. 62/701,559, filed on Jul. 20, 2018.

(51) Int. Cl. G06F 16/23; H04L 9/32; H04L 9/06; G06F 7/58

(52) U.S. Cl. CPC G06F 16/2379; H04L 9/3218; H04L 2209/38; G06F 7/582; H04L 9/0643; H04L 9/0637

(57) ABSTRACT

A method of electing a rotating committee of byzantine fault tolerance (BFT) nodes in a decentralized computer network includes determining that a current committee of BFT nodes has outputted a predetermined number of committed transactions; identifying a plurality of candidate nodes, each respective candidate node of the plurality of candidate nodes having successfully processed, using a proof-of-work (PoW) protocol, a respective transaction of the predetermined number of committed transactions; and selecting, as a new committee of BFT nodes, a subset of the plurality of candidate nodes based on a random function.

### RELATED APPLICATIONS

This application claims priority to U.S. Provisional Patent Application No. 62/701,559, filed Jul. 20, 2018, which is incorporated by reference herein in its entirety.

### TECHNICAL FIELD

The disclosed implementations relate generally to improvements in hybrid consensus protocols for blockchain technology.

### BACKGROUND

With the surging popularity of cryptocurrencies, blockchain technology has caught attention from both industry and academia. One can think of blockchain as a shared computing environment involving peers who can join and quit freely, with the premise for a commonly agreed consensus protocol. The decentralized nature of blockchain, together with transaction transparency, autonomy, and immutability, are critical to cryptocurrencies, drawing the baseline for such systems.

However, top earlier-designed cryptocurrencies, such as Bitcoin and Ethereum, have been widely recognized to be unscalable in terms of transaction rates and are not economically viable as they require severe energy consumption and computation power. Other contenders such as EOS, whose consensus is based on delegated proof of stake (DPoS), achieves significantly higher transactions per second (tps) by making sacrifices in decentralization.

Another consensus model uses Practical Byzantine Fault Tolerant (PBFT) protocols (also referred to herein as BFT). The PBFT protocol ensures safety as long as only one third of the actors in the system are intentionally or unintentionally malicious adversaries (also referred to herein as corrupted), at a time. The Byzantine assumption is easily satisfied in a permissioned environment, but in a permissionless environment, it is generally difficult to guarantee. DPoS attempts to mitigate this problem by adding a barrier to entry for the Byzantine committee, and a costly punishment for those who commit fraud. Namely, stakeholders use a token-weighted vote system to form the Byzantine committee (typically less than 30 nodes). However, decentralization is lost in these protocols because the same nodes are eventually expected to be voted to the committee in each round by the biggest cartel of token holders in the network.

With the growing demand of platforms using public blockchain technology, a secure protocol that enables higher transaction rates while sacrificing the least possible decentralization is needed.

### SUMMARY

This disclosure describes aspects of a hybrid protocol which incorporates a modified form of PBFT and Proof of Work (PoW) consensus mechanisms. The PoW consensus ensures incentivization, committee selection and committee auditing, while the PBFT layer acts as a highly performant consensus with capabilities like instant finality with high throughput, transaction validation, rotating committee for fair trade economy and a compensation infrastructure to deal with non-uniform infrastructure.

Systems, methods, and non-transitory computer readable storage mediums described herein include implementations for electing nodes to BFT committees in hybrid consensus blockchain technologies. In addition, systems, methods, and non-transitory computer readable storage mediums for operating such blockchain technologies are hereby disclosed.

### BRIEF DESCRIPTION OF THE DRAWINGS

The implementations disclosed herein are illustrated by way of example, and not by way of limitation, in the figures of the accompanying drawings. Like reference numerals refer to corresponding parts throughout the drawings.

FIG. 1 is a diagram illustrating a distributed computer network in accordance with some embodiments.

FIG. 2 is a diagram illustrating a sample node of the distributed computer network of FIG. 1 in accordance with some embodiments.

FIG. 3 is a diagram illustrating hybrid consensus principles in accordance with some embodiments.

FIG. 4 is a flow diagram describing a method of electing a BFT committee in accordance with some embodiments.

### DETAILED DESCRIPTION

The implementations described herein describe improvements to hybrid consensus protocols, for example, the hybrid consensus protocol by Pass and Shi, which is hereby incorporated by reference in its entirety. In addition, this disclosure shares common notation with Pass and Shi.

### Hybrid Consensus

Implementations of the hybrid consensus protocol described herein follow a design paradigm where PBFT and PoW are combined together so that the protocol enjoys the best of both worlds. In general, hybrid consensus utilizes PBFT protocols, which by default work in a permissioned setting where all the identities are known a priori, as a fast path dealing with a large amount of incoming transactions. Network nodes implementing PoW protocols chose the BFT committee based on a node's performance in PoW. This combination of protocols provides the basis to deal with dynamic membership and committee switching in the permissionless setting.

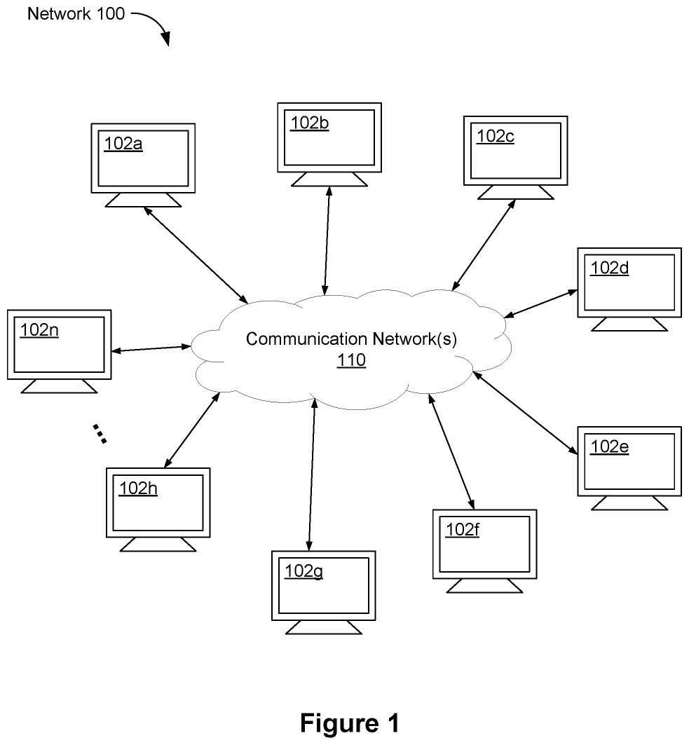

FIG. 1 is an example decentralized computer network 100 in accordance with some embodiments. The network 100 includes a plurality of computing devices 102 (also referred to herein as nodes). Each of the nodes 102 executes one or more blockchain applications. A rotating subset of the nodes 102 serve as members of a BFT committee (e.g., a committee of devices running a PBFT protocol), while the rest of the nodes 102 are not members of the BFT committee (referred to herein as non-members). The non-members run a consensus protocol other than PBFT, such as PoW or PoS. The non-members are responsible for electing nodes to the rotating BFT committee, while the committee members are responsible for processing transactions introduced to the network. The processed transactions are used as a basis for the consensus protocol being run by the non-member nodes. Nodes 102 are communicatively coupled to one or more communication networks 110 (e.g., the Internet, wide-area networks, local area networks, and so forth).

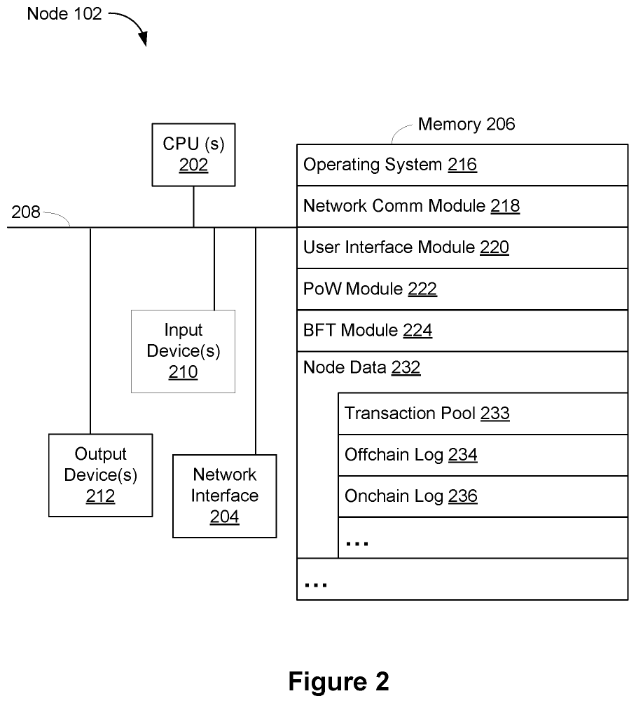

FIG. 2 is a diagram of an example node 102 of the network 112 in accordance with some embodiments. Examples of the node 102 include, but are not limited to, a mobile phone, a tablet computer, a laptop computer, and a desktop computer. The node 102 includes one or more processing units (CPUs) 202, one or more network interfaces 204, memory 206, and one or more communication buses 208 for interconnecting these components (sometimes called a chipset). The node 102 includes one or more input devices 210 that facilitate user input, such as a keyboard, a mouse, a voice-command input unit or microphone, a touch screen display, a touch-sensitive input pad, a gesture capturing camera, or other input buttons or controls. Furthermore, some nodes 102 may use a microphone and voice recognition or a camera and gesture recognition to supplement or replace interfaces requiring contact (e.g., keyboard and buttons). In some implementations, the node 102 includes one or more output devices 212 that enable presentation of user interfaces and display content, including one or more speakers and/or one or more visual displays.

Memory 206 includes high-speed random access memory, such as DRAM, SRAM, DDR RAM, or other random access solid state memory devices; and, optionally, includes non-volatile memory, such as one or more magnetic disk storage devices, one or more optical disk storage devices, one or more flash memory devices, or one or more other non-volatile solid state storage devices. Memory 206, optionally, includes one or more storage devices remotely located from one or more processing units 202. Memory 206, or alternatively the non-volatile memory within memory 206, includes a non-transitory computer readable storage medium. In some implementations, memory 206, or the non-transitory computer readable storage medium of memory 206, stores the following programs, modules, and data structures, or a subset or superset thereof:
Operating system 216 including procedures for handling various basic system services and for performing hardware dependent tasks;
Network communication module 218 for connecting the node 102 to other nodes via one or more network interfaces 204 (wired or wireless) and one or more networks 112, such as the Internet, other wide area networks, local area networks, metropolitan area networks, and so forth;
User interface module 220 for enabling presentation of information (e.g., a graphical user interface for presenting applications, widgets, websites and web pages thereof, and/or games, audio and/or video content, text, etc.) at the node 102 via one or more output devices 212 (e.g., displays, speakers, etc.);
PoW module 222 for executing one or more snailchain protocols using PoW consensus, for example, when the node 102 is not a BFT committee member;
BFT module 224 for executing one or more fastchain protocols using PBFT consensus, for example, when the node 102 is a BFT committee member;
Node data 232, including transaction data from a transaction pool 233, offchain log data 234 (e.g., processed during BFT instances, referred to herein as log), and onchain log data 236 (e.g., processed during PoW instances, referred to herein as LOG).

Each of the above identified elements may be stored in one or more of the previously mentioned memory devices, and corresponds to a set of instructions for performing a function described above. The above identified modules or programs (i.e., sets of instructions) need not be implemented as separate software programs, procedures, modules or data structures, and thus various subsets of these modules may be combined or otherwise re-arranged in various implementations. In some implementations, memory 206, optionally, stores a subset of the modules and data structures identified above. Furthermore, memory 206, optionally, stores additional modules and data structures not described above.

Implementations of the hybrid consensus protocol described herein are designed to operate in a permissionless environment, where each node agrees to update its LOG via a common consensus. Taking network delays into consideration, the view from each node may look different from others. Hence, the network in general is asynchronous and consistency only happens before the last λ, blocks, where λ, is a natural number.

For example, let LOG(t, i) denote the view of LOG from node i at time t. In some implementations, the following security requirements must be guaranteed with overwhelming probability:
Consistency: If i is an honest node, there exists λ>0 independent of t, such that LOG(t−λ, i) is constant with respect to i. This value is denoted LOG(t).
Liveness: Let TXs(t, j) be transactions presented to an honest node j at time t. There exist τ>0, independent of t, such that TXs(t, i)⊆LOG(t+τ, i) for all honest nodes i.

To ensure the above security requirements are met, the following chain quality parameters play an important role in managing chain security.
Q_{fast}=Proportion of honest nodes in a Byzantine committee.
Qₛₙₐᵢₗ=Proportion of last λ blocks mined by honest nodes in a PoW chain.

In a permissioned Byzantine network, it is often safe to assume that chain quality stays above ⅔+ε, where ε is a nonzero number. To satisfy the security requirements in a permissionless setting, protocols must manage chain quality in such a way that the chain quality stays above ⅔+ε with overwhelming probability.

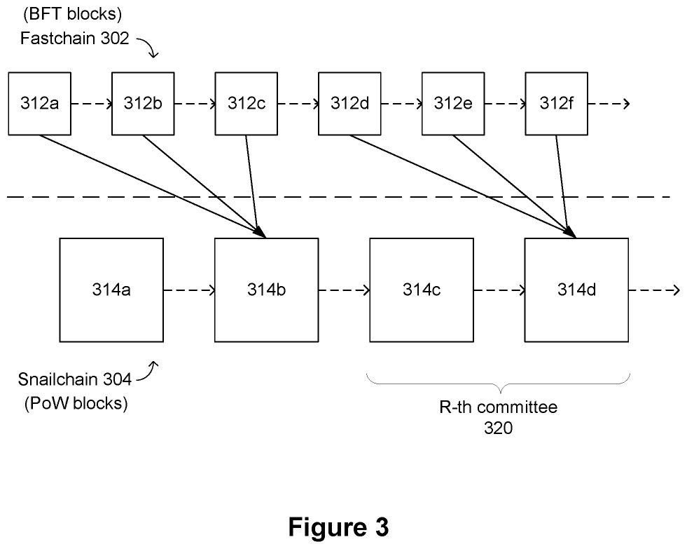

FIG. 3 is a diagram of a sample blockchain structure in accordance with some embodiments. Under the hybrid protocol, the hybrid blockchain is a union of two blockchains. A fastchain 302 and a snailchain 304, whose entire ledger history is denoted by log (lowercase) and LOG (uppercase), respectively. The fastchain can be thought of as the union of DailyBFT chains 312, where each DailyBFT chain includes log data output by the Byzantine committee during the committee's term of service.

Nodes in the fastchain act as Byzantine committee members; they reach consensus via PBFT voting. Transactions and smart contracts are executed on the fastchain to achieve high throughput. Members of the Byzantine committee randomly (or pseudo-randomly, and thus satisfying one or more statistical tests for randomness but produced by a definite mathematical procedure) rotate once every fixed period of time T, and the new committee 320 is selected from PoW miners (nodes who have successfully mined BFT data 312) in a meritocratic fashion. This enhances decentralization, as anyone with a computer can join and become a PoW node.

A permissioned BFT committee in the classical setting of PBFT is a set of nodes, capable of communicating with each other, who vote to agree or disagree to a proposal proposed by the leader. There are no assumptions that these nodes trust one another. In fact, a subset of these nodes may be corrupted adversaries. Through deep analysis of the Byzantine generals problem in the byzantine generals problem, a consensus is always reachable when ⅔+ε of the nodes are honest. Under this assumption, a transaction is processed on the fastchain as follows.
The leader node proposes a set of transactions TXs that it thinks are valid. It then signs off with its digital signature and broadcasts the proposal to other committee members.
Upon receiving the proposal, committee members check for validity of TXs. The other committee members sign off and broadcast if they think the transactions are valid.
Upon hearing ⅔+ε affirmative votes, committee member nodes update TXs to their fastchain log (e.g., log 234 in FIG. 2).
TXs has now been included a fast block, meaning a block on the fastchain (e.g., a block 312 in FIG. 3). The block will be broadcasted to PoW nodes as a message m, containing a digest and a serial number.

Changes to the BFT protocol described above are necessary as it is difficult to guarantee ⅔+ε of the committee members are necessarily honest in a permissionless setting. These changes are discussed in detail later in this disclosure.

Regarding the snailchain, the greatest challenges that PoW-based consensus faces are efficiency and scalability. Slow execution and confirmation time make PoW unfit to develop complex applications, and excessive energy consumption make it environmentally unfriendly. Unlike Ethereum, where transactions and smart contracts are executed by every node on the network, a rotating BFT committee will handle the bulk of heavy lifting while PoW (the snailchain 304) will only be used to select the committee members 320, through a meritocratic process in proof of work.

In some embodiments, the snailchain is that used in Bitcoin (BTC) and Ethereum (ETH), known as the Nakamoto chain. Here, blocks are of the form B=(h_{—1}, blockdata, h), where blockdata are the transactions and digital signatures that are recorded in that block; h is the hash value produced from mining, and h_{—1} is the hash value of the previous block. Through the continuous links of hash data, the blocks form as a chain structure known as the blockchain.

If the Nakamoto chain is used as the snailchain, blockdata can be reduced to a digest of all the transactions that happened in the fastchain during the snail block (e.g., records corresponding to fastchain blocks 312a, 312b, and 312c). The motivation is that, while the data contents in the fastchain are publically accessible to everyone, it would be extremely wasteful to store thousands or millions of copies across the PoW nodes. PoW nodes only have to store enough data to ensure the validity of fastchain transactions, and not the transaction data itself. Only nodes that wish to participate in PBFT will need to synchronize to the fastchain.

The Nakamoto chain has several drawbacks. The most important of which is the practice of selfish mining. As a result of selfish mining, the Nakamoto chain requires the minimal snail chain quality Qₛₙₐᵢₗ>¾ to ensure Q_{fast}>⅔.

In a permissionless setting with mildly adaptive adversaries, Q_{fast} should decay as slowly as possible. Therefore, in some implementations, the underlying snailchain of choice is fruitchain (rather than the traditional Nakamoto chain). Particularly, fruitchain only requires Qₛₙₐᵢₗ>⅔ to ensure Q_{fast}>⅔, even with the assumption that miners will mine selfishly when given the opportunity. For purposes of brevity, this disclosure only briefly describes the basic mechanics of how fruitchain works.

A fruitchain consists of blocks (data) and fruits (subsets of block-level data), arranged in a way that blocks relate to each other like Nakamoto blocks, while each block contains a large number of fruits. In some embodiments, mining difficulty is set so that each block takes 10 minutes to mine, while each fruit take 1 second to mine. Alternatively, difficulty can be set so that blocks take less than 10 minutes or more than 10 minutes to mine, and fruits take less than 1 second to mine or more than 1 second to mine. The asynchronous nature of the network means that honest nodes can only be expected to agree on LOG earlier than t−λ, at time t, for some λ>0. Therefore, nodes will have different views of LOG while they mine fruits, due to the low difficulty of mining. Hence, the protocol allows fruits to be mined out of order, provided that a fruit hangs from a block not too far back in the history.

In embodiments described herein, each fruit is a digest of the corresponding fast block. Fruits bare a serial number given by the fastchain; this is to allow block miners to recover the correct order of transaction history when the dust finally settles. All PoW nodes must verify validity of the fast block, which will become part of the block header, before it is possible to perform any mining calculations. Therefore, transactions using embodiments described herein are validated by all PoW nodes, while still achieving high throughput.

Specifically, consider a block B=(h₋₁^{block}, fruitdata, h) and a fruit F=(h₋₁^{fruit}, digest, serial, h), where h₋₁^{block} is the hash of the previous block, and h₋₁^{fruit} is the hash of any of the most recent λ blocks. In some embodiments, the hybrid protocol described herein sets λ=17 as the recency parameter of the fruit (however, the parameter may be set to 16 or less, or 18 or more in other embodiments). Finally, digest is the hash root of transaction data from the fastchain block. Here is a summary of the snailchain procedure:
Assume Q_{fast}>⅔. After a set of transactions is processed, a fast block is created on average once every second in some embodiments. The Byzantine committee will include transaction digest, a serial number, and broadcast to the PoW nodes as a message m.
PoW miners solve an easier puzzle to package m in a fruit. Mining difficulty is set so a fruit is created once every second in some embodiments, matching the block frequency in the fastchain. Fruits can be mined out of order, as their parent hash can be pointed to any of the last λ blocks of the snailchain.
The snailchain block (e.g., 314d) represents the finality of the transaction. A block is mined once every 10 minutes in some embodiments, and it contains all the fruits with contiguous serial numbers mined up to that period (e.g., 312d, 312e, 312f).

Embodiments using fruitchain as the underlying snailchain for hybrid consensus do so because fruitchain is more resistant to selfish mining. The required snailchain quality needed to maintain fastchain security is Qₛₙₐᵢₗ=⅔+ε on a PBFT-Fruitchain hybrid, as opposed to Qₛₙₐᵢₗ=¾+ε on a PBFT-Nakamoto hybrid. The extra chain quality required by Nakamoto chain is to counteract against security loss from selfish mining practices.

There are three types of blocks that require further explanation. Fast block, the fruit and snail block. They interact in the following manner: the fast block is produced by PBFT and broadcasted to PoW nodes as a message m. PoW nodes will first mine m as a fruit, before packaging fruits into a block.

A fruit is the tuple f=(h₋₁; h′; η; digest; m; h), while a block is the tuple b=((h₋₁; h′; η; digest; m; h), F) where:
h−1 points to the previous block's reference, only useful for fruit verification.
h′ points to a block that contains the fruit, only useful for block verification.
η is the random (or pseudo-random) nonce.
digest is a collision resistant hash function, value used to check the fruit's validity.
m is the record contained in the fruit.
h=H(h−1; h′; η, d(F);m) is the hash value of the block and/or fruit.
F is a valid fruitset as defined in Fruitchain.

The blockchain chain={chain[0], chain[1], . . . , chain[l]} is a collection of individual blocks ordered by index i, where chain[i].h₋₁=chain[i−1].h, and l is the length of chain. A fruit f is referred to as λ-‘recent’ with respect to chain if f ε {chain[l−λ+1].F ∪ . . . ∪ chain[l].F}. Some embodiments described herein choose λ=17.

From a block data standpoint, there are two types of blocks in embodiments described herein, fast block and snail block. The hash algorithm used these blocks is referred to as hash. In some embodiments, the hash algorithm is Sha3.

In some embodiments, the fast block contains one or more of the following:
ParentHash: Hash value of parents block's header.
StateRoot: Hash root of the state Merkle tree, after all transactions are executed.
Transactions root: Hash root of the Merkle tree with each transaction in the transactions list.
ReceiptHash: Hash root of the Merkle tree with receipts of each transaction in the transactions list.
Proposer: Address of proposer of the transaction
Bloom: The Bloom filter
SnailHash: Hash of the snail block mining is rewarded to
SnailNumber: Height of the snail block mining is rewarded to
Number: Number of ancestor blocks
GasLimit: Limit of gas expenditure per block
GasUsed: Total gas used for this block
Time: Timestamp
Extra: Preallocated space for miscellaneous use

In some embodiments, the snail block contains one or more of the following:
Parent hash (h−1): Hash value of parents block's header.
Uncle hash: Hash value of uncle blocks.
Coinbase: Coinbase address of the miner.
PointerHash: The block hash which the fruit is hanging from.
PointerNumber: The block height which the fruit is hanging from.
FruitsHash: Hash data of the included fruits in a block
Fasthash: Hash data of the fast block
FastNumber: Block height of the fastchain.
SignHash: Hash of the digital signatures of the PBFT committee
Bloom: The Bloom filter
Difficulty: Difficulty used by the block
FruitDifficulty: Difficulty used by the fruit
Number: Number of ancestor blocks
Publickey: EC-Schnorr public key of the leader who proposed the fast block
ToElect: Whether PBFT committee members will rotate after this block
Time: Timestamp
Extra: Preallocated space for miscellaneous use
MixDigest: Digest of the fast block
Nonce: Block nonce

As described above, the fruitchain consists of a blockchain with each block containing its own set of fruits. Transactions executed by the BFT will be initially packaged as a record m to be mined as a fruit. Fruits more recent than a recency parameter R will be packaged into a block when the next block is mined.

In some embodiments, a node operating as a PoW miner will run only one mining algorithm that produces hash values h from a random (or pseudo-random) oracle (e.g., function). A fruit is mined when [h]−κ<D_{Pf}, and a block is mined when [h]−κ<D_{P}, where D_{Pf} and D_{P} are the mining difficulty parameter of the fruit and block respectively. The tuple (R, D_{P}, D_{Pf}) determines mining process.

In order to discourage the deployment of ASICs, some embodiments make the recency parameter κ=κ(t) time dependent. In some embodiments, VRF will generate and broadcast a new κ(t) (to fall within the valid range) using VRF once every 3 months. Alternatively, a new κ(t) may be generated and broadcast less often than every 3 months or more often than every 3 months.

In some embodiments, the mining algorithm tentatively chooses DP and DPf such that expected times to mine a fruit and a block are 1 second and 10 minutes, respectively. Fruits are easier to mine than blocks, and therefore miners are less incentivized to join or form mining pools. This make PoW a fairer process. Since fruit mining difficulty is low, it is quite likely that two fruits are mined simultaneously. One way of determining which is the valid fruit is by choosing the fruit with a lower hash value.

Fruits are not stable until they are written in a block. Therefore, in some embodiments, the mining reward is paid to the block miner, who then distributes at least some of the reward to miners of fruits that are included in the block.

One advantage of the fruitchain protocol is that fruits can be mined in any order, and this can make mining highly parallel. This is particularly useful when combined with sharding.

In some embodiments, a world state is a database running in the background (e.g., in the form of a Merkle tree) that provides a mapping between addresses and account state. Being an immutable data structure, it allows any previous state to be reconstructed by altering the root hash accordingly.

In some embodiments, the account state consist of the following information.
Nonce: Number of transactions or contract creations made by this account. The value of this number is non-decreasing with respect to block height.
Balance: A non-negative value indicating the amount of tokens held by the account.
CodeHash: This stores the hash digest of the contract code, that will be executed should this address receive a message call. This field is strictly immutable and should not be changed after construction.
StorageRoot: The root hash of the storage associated with each account.

Regarding transactions and execution, a transaction is a cryptographically signed message initiated by a client user.

In some embodiments, a message takes the following form:
AccountNonce: Number of transactions sent by the sender.
GasPrice: Number of Wei to be paid per unit of gas for this transaction.
GasLimit: Maximum amount of gas should be used for this transaction.
Recipient: Address of the beneficiary for this transaction.
Payload: Amount of token to be transacted.
Code: Virtual machine code for smart contract deployment.
Data: Miscellaneous use.
V,R,S: Cryptographic values corresponding to the signature of the transaction, and used to determine the sender of the transaction.

In some embodiments, the transaction goes through the following steps to reach finality.
The transaction, along with a set of other transactions, accumulate in a pool of transactions (referred to herein as txpool).
The leader of the PBFT committee selects a subset of txpool that it believes is valid, and makes a proposal to other committee members.
Committee members check the validity of all transactions proposed by the leader, and if they agree, sign and broadcast to other committee members.
Upon hearing more than ⅔ affirmative votes, a consensus is formed. The transaction is then broadcasted to PoW nodes as a message.
PoW miners first validate the transactions of the block, which becomes a part of the block header, and package them in a fruit. Fruits can be mined in arbitrary order.
When the next block is mined, the block miner will package the biggest contiguous set (as per fruit serial number from fast block) to the block where finality is reached.
Snailchain forks are resolved by aligning to the branch with the highest sum of fruit difficulty. The probability of two branches with equal difficulty sum is negligible.

Regarding security, as discussed above, PBFT operates in a permissioned environment. The Byzantine assumption that less than ⅓ of the participating nodes are corrupt is quite conservative. In a permissionless environment however, this means the protocol needs to maintain fastchain quality Q_{fast}>⅔, for the chain to sustain consistency and liveness.

Some embodiments of the protocol described herein assume the following about the operating environment (e.g., network 100 in FIG. 1), and these assumptions are referred to as an adversary model:
Let Qₛₙₐᵢₗ be the proportion of hash power controlled by honest mining nodes. Assume Qₛₙₐᵢₗ>⅔, this is slightly more conservative than the security assumptions made by leading projects such as Bitcoin and Ethereum, where effectively they only assume Qₛₙₐᵢₗ>½.
Assume adversaries are mildly adaptive. In an adaptive model, a node can be honest before being elected to the committee, and suddenly turn adversarial once it is elected.

In a mildly adaptive model, this process is not instantaneous, but rather occurs over a period of time.
A node that becomes corrupt precisely after T fastchain time steps of election is called a τ-agile adversary. No assumptions are made on the value or distribution that T should take.
BFT committee members are elected from PoW nodes with a meritocratic, albeit permissionless, process. No assumptions are made regarding the nodes themselves to possess advanced cyber security measures, and honest nodes (e.g. committee members) may turn adversarial when they are hacked by an external party.

In the fastchain, committee members run an offchain process (referred to herein as a DailyBFT instance) to decide a daily log, whereas non-members count signatures from committee members. This extends security to committee nonmembers and late-spawning nodes. This carries with it a termination agreement which requires that all honest nodes agree on the same final log upon termination. In DailyBFT, committee members output signed daily log hashes, which are then consumed by the Hybrid Consensus protocol. These signed daily log hashes satisfy completeness and unforgeability. During a process referred to as keygen, public keys are added to a list of keys. On receiving a comm signal, a conditional election of the node as a committee member happens. The environment opens up the committee selectively. Additional details regarding committee selection are described below.

Each node can be a committee member or a committee non-member. When a node is operating as a committee member, the protocol forks a BFT virtual node, sometimes referred to as BFTpk, then starts receiving the TXs (transactions). The log completion is checked and stopped if and only if the stop signal has been signed off by at least a third of the initial comm distinct public keys. During this process, a continuous “Until done” check happens and once completion of gossip happens at each step, all the stop log entries are removed. When the node is operating as a non-member, on receipt of a transaction, the message is added to history and signed by a third of the initial comm distinct public keys. The signing algorithm tags each message for the inner BFT instance with the prefix 0, and tags each message for the outer DailyBFT with the prefix 1 to avoid namespace collision.

A mempool subprotocol initializes TXs with 0 and keeps track of incoming transactions with a Union set. On receiving a propose call, it adds the transaction to its log and communicates using a gossip protocol. The subprotocol also supports query methods to return confirmed transactions. By keeping track of transactions in a set, the subprotocol purges the transactions that have already been confirmed.

In some embodiments, BFT committee instances are switched after a fixed period of time (with the snailchain as a logical clock). The snailchain is expected to produce one block every 10 minutes in some embodiments, so the protocol sets a rotating frequency of 144 blocks. In accordance with some embodiments a new committee is formed simply by the miners of the latest csize number of blocks inside snailchain (e.g., by the miners of blocks 314c and 314d in FIG. 3).

### Committee Election

Some embodiments of the protocol described herein may be vulnerable to selfish mining attack strategies. The damage of selfish mining is magnified in the hybrid consensus setting, because power is more concentrated in the top few high hash nodes. If a selfish miner controlled more than 25% of the blockchain's hash power, it could control more than 33% of block production. Under the election procedure, the selfish miner is likely to control over ⅓ of the BFT committee. If the selfish miner happens to be adversarial, the fastchain will lose the liveness property.

There are two undesirable extremes that embodiments of the protocol described herein need to balance:
In one extreme, BFT members are randomly (or pseudo-randomly) selected using a verifiable random (or pseudo-random, and thus satisfying one or more statistical tests for randomness but produced by a definite mathematical procedure) function (VRF). However, a randomly elected BFT committee would be vulnerable against sybil attacks.
In another extreme, BFT members are selected with a probability that is proportional to their hash power (e.g., nodes with higher hash power are more likely to be elected). However, a BFT committee elected in this way would be vulnerable against mining pools which are rich in hash power.

A proposed solution is as follows. When an honest BFT node's chain reaches λ in length, the node publishes the unique miner IDs of every fruit in the chain as candidates (or, every miner ID who mined more than v fruits). The new BFT committee is then randomly (or pseudo-randomly) selected from the candidates with uniform probability.

Sybil attacks are ineffective under this scheme, as this scheme requires a minimal level of PoW to become a candidate. Neither will it be easy for a large mining pool to compromise the BFT committee, since a fruit is orders of magnitude easier to mine than a block.

The uniformly distributed random (or pseudo-random) number used in some embodiments of this scheme is similar to VRF where the seed is determined by the seed used in a previous committee selection, as well as the proposed randomness from recent csize blocks. As opposed to Algorand, for example, this scheme does not count stake weights for this part of selection.

Nodes that are chosen by random (or pseudo-random) functions would have a certain probability of not being online. Electing nodes that are not connected to the network would cause the fastchain to lose chain quality. As such, in some embodiments, nodes would need to manually flag that they are willing to participate in the committee election. In some embodiments, this can be achieved by broadcasting online presence proximate to the time of the election.

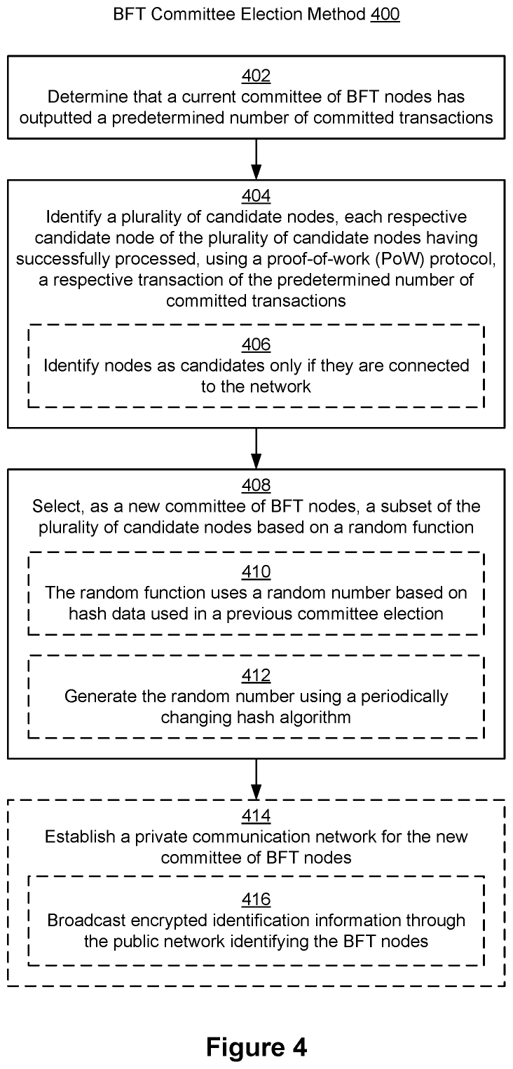

FIG. 4 is a flow diagram illustrating an example method 400 for electing nodes to a BFT committee in accordance with some embodiments. Method 400 is, optionally, governed by instructions that are stored in a computer memory or non-transitory computer readable storage medium and that are executed by one or more processors of one or more nodes 102. The computer readable storage medium may include a magnetic or optical disk storage device, solid state storage devices such as Flash memory, or other non-volatile memory device or devices. The instructions stored on the computer readable storage medium may include one or more of: source code, assembly language code, object code, or other instruction format that is interpreted by one or more processors. Some operations in method 400 may be combined and/or the order of some operations may be changed.

Method 400 is performed by one or more processing units (e.g., CPU(s) 202) of a node 102 and memory (e.g., 206) of the node 102 storing programs for execution by the processing cores.

A node operating as a PoW node (not a committee member) determines (402) that a current committee of BFT nodes has outputted a predetermined number of committed transactions. For example, when a threshold (e.g., ⅔+ε) of BFT nodes has signed one or more transactions, the node 102 determines that the committee has agreed that the one or more transactions are valid and are ready to be mined on the snailchain.

The node, along with other nodes in the network, process these committed transactions by mining snailchain blocks. Eventually, the node identifies (404) a plurality of candidate nodes, each respective candidate node of the plurality of candidate nodes having successfully mined (or otherwise processed), using a proof-of-work (PoW) protocol (or any other snailchain consensus protocol), a respective transaction of the predetermined number of committed transactions. Stated another way, when the number of recently mined blocks on the snailchain surpasses a threshold (e.g., “csize” as described above), the node identifies the PoW nodes who mined the previous blocks as candidates for election to the next BFT committee.

In some embodiments, only nodes who are confirmed to be connected to the network can be identified (406) as candidates. In some embodiments, additionally or alternatively, nodes must signal willingness to be elected to the next BFT committee in order to be, or to remain, identified as a candidate.

The node selects (408), or otherwise classifies, as a new committee of BFT nodes, a subset of the plurality of candidate nodes based on a random (or pseudo-random) function. In some embodiments, the random (or pseudo-random) function uses (410) a random (or pseudo-random) number based on hash data used in a previous committee election. In some embodiments, the node generates (412) the random (or pseudo-random) number by using a periodically changing hash algorithm. More details of these operations are described below.

In some embodiments, if the node is itself elected to the BFT committee, the node establishes (414) a private communication network for the new committee of BFT nodes. In some embodiments, the node establishes the private communication network by broadcasting (416) encrypted identification information through the public network identifying the BFT nodes; this identification information can only be decrypted by other members of the BFT committee. More details of these operations are described below.

The ability to establish a secure communication channel between committee nodes is central to the success of building a decentralized, high performant and secure network. There is a common misconception that traditional PoW networks like Bitcoin and Ethereum are slow because mining puzzles are too difficult to solve. On the contrary, the mining puzzle is nothing but a kill-time mechanism, so that the nodes have enough time to synchronize due to network delays.

To make matters worse, the aggregate network traffic required to achieve synchronization of all nodes grows in polynomial order with respect to the number of nodes in the network. As the network grows, its throughput decays rapidly, making development of its ecosystem unsustainable. The reason why PBFT-based blockchains achieve far better transactions per second than PoW is that the number of nodes required to reach consensus on a transaction is much smaller (typically 10 to 30), and that stays constant regardless of the total number of nodes in the network. On the other hand, as the network grows and the number of PBFT nodes remains the same, decentralization is lost.

Embodiments of the hybrid consensus protocol described herein aim to achieve high throughput by using a rotating BFT committee to process transactions, and PoW to determine who gets elected to the committee. There lies a problem regarding how BFT committee members communicate with each other about their voting decisions. If BFT committee members use the gossip protocol of the PoW network, voting messages will need to traverse the entire PoW network before committee members hear about it. A real life experimental deployment of this network resulted in a throughput of 80 tps, a marginal improvement from Bitcoin cash.

On the other hand, BFT committee members can make their communication channel known to the public, in order to establish direct peer-to-peer communications during the voting process. However, BFT nodes may be corrupted or otherwise attacked (e.g., DDoS'ed), and fast chain quality will rapidly deteriorate. Therefore, the central network-related issue to address is regarding how to protect the identities of rotating committee members while achieving direct peer-to-peer communication (414 in FIG. 4).

In some embodiments, the following protocol is used to establish a private communication network for the nodes on the BFT committee:
If a PoW node mined a threshold (e.g., v=100) of fruits over the last threshold (e.g., 144) of snailchain blocks, and is willing to participate in PBFT, then it becomes a member of the candidate committee (404 and 406 in FIG. 4).
Hash data derived from fruits mined by node i is used for an interval I(i) ⊂ [0,1]. Another random (or pseudo-random) number, Γ, is generated from snailchain historical hash data (far enough so all nodes have synchronization). If Γ ε I(i), then node i has been elected to the committee. The value of F should be the same across all honest nodes to achieve consensus.
Repeat the previous operation until enough committee members have been generated.
Let Γ₁, . . . , Γ_{csize} be the generated uniform random numbers. Elected nodes can compute locally from snailchain data, the addresses of other members of the next committee. Suppose these are add₁, . . . , add_{csize}.
Suppose node addᵢ is a new committee member. It will broadcast its IP address (or other data necessary to establish a direct communication channel), encrypted with the public key of add₁, . . . , add_{csize}, using the gossip protocol.
When another committee member adds hears this message, it will decrypt it with its private key, and find csize−1 lines of gibberish and one line containing the IP address of node addᵢ, while non-committee members will be unable to decrypt this message.

This protocol allows each committee member to locally build a table of IP addresses of other committee members, which will allow high throughput communication while hiding their IP address from the public. One security issue to consider is that if an adversary happens to be a committee member, she can broadcast the entire list of committee IP addresses to the general public. All of the committee nodes can be DDoS'ed in a short period of time, and the mildly adaptive adversary assumption is breached.

The following adjustment can address this security issue. Assume there are csize members in the committee and the protocol creates a private gossip network, with each node gossiping to gsize other nodes. A typical value of these parameters could be csize=31 and gsize=4. Other embodiments set csize to greater than or less than 31, and set gsize to greater than or less than 4.
Generate a matrix A from historical hash data, such that Ai,j ε {0, 1}, and columns and rows of A sum up to gsize. The matrix A should be the same across all honest nodes to achieve consensus.
Give label i to the committee member who is elected by the random number Γi.
Committee member i will only encrypt its IP address using the public key of j, provided if Aij=1.

The private gossip network of csize nodes each gossips to gsize other nodes. If an adversarial node made it to the BFT committee, the greatest damage would result in the BFT committee losing gsize+1 nodes. Setting gsize big could improves the blockchain's throughput, while a smaller gsize improves the chain's security. Setting gsize<⅙*csize generally gives a good balance. This allows the protocol to achieve over 2000 transactions per second.

If gsize is too small, the protocol is at risk of an eclipse attack, particularly when accompanied by a bad choice of A. Roughly speaking, if A is very close to a direct sum of lower dimensional matrices, the resulting graph will start to have isolated regions, making some nodes a more critical connector than others. The algorithm to consistently generate robust choices of A relies on the representation theory of symmetric groups.

Regarding physical timing restrictions, conventional consensus designs by default allow miners and/or committee members/leaders to re-order transactions within a small timing window. This raises a problem for some decentralized applications such as commercial exchanges where the trading fairness requires the timing order between transactions to be carefully preserved, or otherwise malicious (or, even normal rational) participants will have the incentive to re-order transactions, or even insert their own transactions, to gain extra profits. This incentive will be magnified under high throughputs. In some cases, such malicious re-ordering is impossible to distinguish because naturally network latency will cause reordering, and such latencies can only be observed by the receiver itself.

To support decentralized advertisement exchanges, such problems may be addressed by incorporating a restriction referred to herein as a sticky timestamp. More specifically, with a heuristic parameter T_{Δ}, when proposing transactions, a client is required to put a physical timestamp T_{P} inside the metadata of the transaction, and this physical timestamp is signed together with the other parts of the transaction. Later when validators inside BFT verify the transaction, the BFT members will perform extra checks based on the timestamp.

At the stage of materializing logs inside BFT, the leader sorts the transaction batch according to its physical timestamps and breaks ties (though very unlikely) with the sequence number. Additionally or alternatively, this operation can enforce the order later in the evaluation and verification.

This set of modifications results in several extra properties:
The order of transactions from any node Ni is internally preserved according to their physical timestamps. Thus, the sequence order of these transactions is strictly enforced. This will get rid of the possibility of some malicious reordering that involves two transactions from the same node.
The order within a batch of transactions output by the BFT committee is strictly ordered by timestamps.
Nodes cannot manipulate fake physical timestamps because of the timing window restriction.

In some implementations, timing issues resulting from the modifications described above are dealt with by requiring nodes to present evidence of synchronized clocks before they can be elected to a committee.

### Data Sharding

An important modification over conventional hybrid consensus protocols is the addition of computation and data sharding support. Embodiments described herein use a speculative transaction processing system over shards. Specifically, DailyBFT instances are indexed into a deterministic sequence DailyBFT[1 . . . R]. Multiple sequences of DailyBFT instances are allowed to exist at the same time. To be precise, the t-th DailyBFT sequence is denoted by shard St. For simplicity, the number of shards is fixed as C. Each DailyBFT is a normal shard. Besides C normal shards, a primary shard Sp is composed of csize nodes. The job of the primary shard is to finalize the ordering of the output of normal shards as well as to implement the coordinator in distributed transaction processing systems. And the normal shards, instead of directly connecting with a hybrid consensus component, submit logs to the primary shard, which in turn talks to hybrid consensus components.

In some embodiments, no two shards (either normal or primary) are allowed to share common nodes, which can be enforced in the committee selection procedure. The election of multiple shards is similar to the election procedure described above.

In some embodiments, the state data (in terms of account range) is partitioned uniformly into C shards. This ensures that every query to the corresponding shard will return a consistent state. Since metadata is included for each data unit, data is split into units of data sectors and each data sector is assigned an address. The protocol includes a mapping from data position to data sector address. For brevity, the discussion continues only at the level of data sectors. Each data sector DS[addr] has metadata of rts, wts, readers, writers.

The partition principle is assumed to be public and is given the address addr. Its host shard can be obtained by calling the function host(addr).

If every normal shard (when the number of adversaries is not large) is treated as a distributed processing unit, the design of logical timestamps can be incorporated in distributed transaction processing systems, which empowers the processing of transactions. In some embodiments, a simplified version of MaaT is used, such that the protocol does not perform auto-adjustments of timestamps for other transactions.

Normal shards act as described in DailyBFT, with the exception of the following changes to make them compatible for parallel speculative execution.

Each primary shard collects output from all of the normal shards. The data dependency of transactions can be easily inferred by the transaction metadata. As such, if a transaction visits multiple remote shards, the transaction will leave traces in all of the shards involved. When a normal shard submits logs to the primary shard, the normal shard will also write to the snailchain.

When the primary shard receives (or fetches from the snailchain) a batch of transactions from a shard, the primary shard will check if it has received from all the shards transactions within this batch. If after a certain timeout it has not received transactions from a particular batch, that batch has failed. In this case, a whole committee switch will be triggered at the next day starting point. After receiving all of the shards' logs, the primary shard sorts the transactions based on their commit timestamps. If a transaction has an earlier batch number, it will be considered as the first key in the sorting; however, if its physical timestamp violates the timestamps from many shards, that batch is determined to be invalid and all of the transactions inside that batch are aborted. After sorting, the primary shard filters all of the transactions and keeps a longest non-decreasing sequence in terms of physical timestamps. The primary shard outputs the log to the hybrid consensus component as that day's log.

### Virtual Machines

One reason to use a virtual machine (VM) is to meter usage with a transaction fee in a PoW model. A basic problem lies in crude mathematical notations used in conventional virtual machine specifications. In additional, some conventional consensus protocols use containers instead of VMs. One conventional blockchain framework is Hyperledger's Fabric framework. If one sets out to convert Fabric's permissioned nature into permissionless, one of the foremost challenges would be to solve the chaincode issue. What this means is while it is possible to keep a chaincode/smart contract in a single container, this is not a scalable model for a public chain. Having such a model for a public chain means having to run several thousand containers, per se, several thousand smart contracts on a single node (because each node maintains a copy).

There have been attempts in conventional protocols to be able to run a certain maximum number of containers per node. The limit currently is 100 pods per node, per se, approximately 250 containers per node. Even with storage techniques like brick multiplexing, the maximum possible number of containers could not possibly reach, for example, 1000. Those who wish to scale containers usually prefer horizontal scaling rather than a vertical scaling, as the latter significantly increases complexity of design decisions. There is no one-size-fits-all rule for a cluster scale configuration, since that depends on the workload.

Regarding the container scenario, one solution is to use containers in a serverless architecture. But consider a scenario where greater than 2000 contracts are online and the concurrent requests, i.e., invocation calls to chaincode (a moving window) at a time exceed the maximum container value, the protocol would then be faced with the problems described above. Therefore, it is only advisable to add a throttling rate limit on the maximum concurrent requests. This severely limits the transactions per second (TPS) from the consensus.

In contrast to conventional VMs which handle incentivization and rotating committee selection, embodiments of a VM as described herein carry out actual consensus and voting based off of PBFT based hybrid consensus. In some embodiments, the VM derives a stack-based architecture utilizing the Keccak-256 hashing technique and the Ellipticcurve cryptography (ECC) approach.

In some embodiments, the hybrid consensus protocol as described herein uses a VM-like bytecode execution platform for launching smart contracts. In some embodiments, nodes run a VM only on the fastchain, so they could manage invocation calls on a per-need basis.

### Incentive Design

The PoW protocol has a proven track record of attracting computational resources at an unprecedented rate. While existing PoW networks such as bitcoin and ethereum have been successful in their own right, the computational resources they attracted have been nothing more than very powerful hash calculators. They cost a lot of electricity to run, and produce nothing useful.

In some embodiments, a compensation infrastructure balances the workload of BFT committee members and non-member nodes. A new incentive design for PoW is therefore necessary, in which participating resources can be redirected to do useful things, such as scaling transactions per second (referred to as TPS), and providing on-chain data storage.

Ethereum gas price, an example of a conventional gas fee protocol, is determined by a spot market with no possibility of arbitrage, similar to that of an electricity spot market. This market is incomplete, and therefore the fundamental theorem of asset pricing does not apply. Thus, the underlying gas price follows a shotnoise process known for its high volatility.

In some embodiments, an incentive design uses a “gas market place,” where gas is traded as futures, and this market is complete in the infinitesimal limit. This significantly reduces gas price volatility compared to, for example, Ethereum.

The provision of incentives for successfully mining a block (e.g., by calculating the correct hash) provides an incentive for users to scale their processing power in order to increase the probability of calculating the correct hash and collecting the mining reward. One piece of hardware, called an application-specific integrated circuit (ASIC), has been very popular in this regard. However, increase in the use of ASICs to collect mining rewards has led to mining farms that require large amounts of power to operate.

In some embodiments, the PoW mining algorithm is designed to be fundamentally resistant to ASICs. ASICs are far better hash calculators than any general purpose computer, but they can only run one procedure and cannot be reprogrammed. Therefore, if the mining algorithm is periodically modified (e.g., once every few months (12000 snailchain blocks)), then it would not be profitable for anyone to build ASICs for mining, as by the time an ASIC has been designed and produced to run a particular mining algorithm, the mining algorithm would be switched out, rendering the ASIC useless for calculating hashes.

Some embodiments include one or more of the following conditions for ASIC resistance:
There exists a large pool of potential mining algorithms (e.g. 2048!) and it is unfeasible to hard code each of them to an ASIC chip.
The mining algorithm is capable of automatically switching without having human interference, for example, via a hard fork.
The correctness of the new mining algorithm must be provable (so all nodes can come to consensus), and the process must be verifiably unpredictable (so it is impossible to secretly build ASIC miners before the switch).

Conventional PoW mining repeats the hash(v(nonce)) calculation, where v(nonce) is a function that takes the mining nonce and block header and pads them to the correct dimension.

Instead, embodiments of the improved PoW mining technique described herein use a modified hash function, hash(ρ(g)*v(nonce)). Here, G is a large group (e.g. S₂₀₄₈) and g ε G, ρ: G→V is a homomorphism from G to a vector space V, so that the matrix multiplication ρ(g)*v(nonce) is valid on V.

As such, simply replacing ρ(g) with another ρ(g) for a different element g′ ε G results in a completely different hash algorithm. Since G=S₂₀₄₈ is a large group, |G|=2048!, the space of potential hash algorithms to choose from is 2048! (the exclamation point denotes factorial). In some embodiments, the new group element g′ is generated from hash data of snailchain, through application of group representation theory. The new mining algorithm is therefore provable and unpredictable. The aforementioned techniques are examples of operations 410 and 412 in method 400 of FIG. 4.

In some embodiments, gas price is traded in a futures market, where the futures contract is manifested by a smart contract. For example, a contract is executed as follows.
Party A agrees to pay party B a particular amount, while party B promises to execute party A's smart contract, between time T0 and T1, that cost exactly 1 gas to run.
Party B will contribute the particular amount to a pool corresponding to the committee C that executed party A's smart contract. This is referred to as the gas pool.
Members of committee C will receive an equal share of the gas pool, and return an average cost per gas μ for the pool.
If B contributed less than μ, B must make up for the difference by paying another party who contributed more than μ.
If B contributed more than μ, B will receive the difference from another party who contributed less than μ.

Under this scheme, liquidity providers are rewarded when they correctly anticipate network stress, and hence create a complete market in the infinitesimal limit. Price volatility is absorbed by the averaging mechanism in the gas pool, making the price itself a good indicator of network stress.

Our intention is to ensure gas price is traded roughly within a predetermined interval. Hence, if the moving average price is sustained above a certain threshold, a new PBFT committee is spawned through a quantum appearance process. On the other hand, if the moving average price is sustained below a certain threshold, an existing PBFT committee will not be given a successor after it finished serving its term.

In some embodiments, the proportion of mining reward is distributed as follows.
Let n be the number of PBFT committee running at a certain instance, and α>1.
Proportion of mining reward going to PBFT nodes is n/(α+n),
Proportion of mining reward going to PoW nodes is α/(α+n).

Accordingly, in later stages of the chain, new nodes are incentivized to contribute to the blockchain's overall TPS, hence ensuring continued scalability of the chain. The parameter a represents the number of PBFT committees when the mining reward is divided 50/50.

### Data Storage

Embodiments of the hybrid consensus protocol described herein aim to achieve 10,000 TPS on each shard, and the number of shards is designed to grow linearly with respect to the volume transaction demand (roughly correlating to the number of nodes). The bitcoin network has generated roughly 170 gb of transaction history data over the course of 10 years at 10 TPS. Going from 10 to 10,000, the same volume of data would be generated every 3 days. At 100 shards, or 1 million TPS, the same volume of data would be generated every 45 minutes. Hence, requiring every node to store the entire transaction history like bitcoin would no longer be feasible in a high TPS public chain.

One solution includes implementing a periodic checkpoint (e.g., once every few hours or days), at which every node is only required to store transaction history from a previous number of check points. This solution, however, does not account for the rest of the transaction history (before the previous checkpoints), and there is no incentive to store that previous history.

Embodiments of the hybrid consensus protocol described herein therefore implement another solution, which includes seamlessly merging transaction processing with the storage capability of a decentralized storage system (e.g., a content-addressable, peer-to-peer system such as an InterPlanetary File System (IPFS)) in a unified incentive infrastructure. This provides a solution for the storage of transaction history, and allows a plethora of sophisticated applications to be running completely decentralized on the network architecture.

In some embodiments, data storage is possible in two levels:
Level 1: Data is stored on every PoW node. It is the most permanent method of storage but also the least efficient. It is predominately designed to store the block's Merkel root, and other information of high value density. Users pay a gas fee to PoW miners.
Level 2: Data is stored in an IPFS-like file system where a limited copy of the data is distributed to storage nodes throughout the chain. This is designed for storing the bulk of the network's historical transactions and data-heavy decentralized applications. Users pay miners a fee for both storage and retrieval.

### Notes Regarding the Disclosure

Reference has been made in detail to various implementations, examples of which are illustrated in the accompanying drawings. In the above detailed description, numerous specific details are set forth in order to provide a thorough understanding of the invention and the described implementations. However, the invention may be practiced without these specific details. In other instances, well-known methods, procedures, components, and circuits have not been described in detail so as not to unnecessarily obscure aspects of the implementations.

It will be understood that, although the terms “first,” “second,” etc. may be used herein to describe various elements, these elements should not be limited by these terms. These terms are only used to distinguish one element from another. For example, a first device could be termed a second device, and, similarly, a second device could be termed a first device, without changing the meaning of the description, so long as all occurrences of the first device are renamed consistently and all occurrences of the second device are renamed consistently. The first device and the second device are both device, but they are not the same device.

The terminology used herein is for the purpose of describing particular implementations only and is not intended to be limiting of the claims. As used in the description of the implementations and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” may be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” may be construed to mean “upon determining” or “in response to determining” or “in accordance with a determination” or “upon detecting” or “in response to detecting” that the stated condition precedent is true, depending on the context.

The foregoing description, for purpose of explanation, has been described with reference to specific implementations. However, the illustrative discussions above are not intended to be exhaustive or to limit the invention to the precise forms disclosed. Many modifications and variations are possible in view of the above teachings. The implementations were chosen and described in order to best explain the principles of the invention and its practical applications, to thereby enable others skilled in the art to best utilize the invention and various implementations with various modifications as are suited to the particular use contemplated.

What is claimed is:

1. A method of electing a rotating committee of byzantine fault tolerance (BFT) nodes in a decentralized computer network, comprising:
determining that a current committee of BFT nodes has outputted a predetermined number of committed transactions;
identifying a plurality of candidate nodes, each respective candidate node of the plurality of candidate nodes having successfully processed, using a proof-of-work (PoW) protocol, a respective transaction of the predetermined number of committed transactions; and
selecting, as a new committee of BFT nodes, a subset of the plurality of candidate nodes based on a random or pseudo-random function.

2. The method of claim 1, wherein identifying a plurality of candidate nodes includes:
determining whether each respective candidate node is connected to the network at a time proximate to the identifying; and
forgoing identification as a candidate node any node that is not connected to the network at the time proximate to the identifying.

3. The method of claim 1, wherein the random or pseudo-random function uses a uniformly distributed random number generator which generates a random number based on hash data used in a previous committee election.

4. The method of claim 3, wherein generating a random number based on hash data includes using a hash algorithm, and wherein the method further comprises periodically changing the hash algorithm.

5. The method of claim 1, including
successfully processing, using a proof-of-work (PoW) protocol, one or more transactions outputted by a threshold number of byzantine fault tolerance BFT nodes in the current BFT committee of the network; wherein,
outputting committed transactions includes using a BFT protocol to commit transactions to a record of committed transactions, and
processing transactions includes using a PoW protocol to add successive records to a chain of records.

6. The method of claim 5, wherein:
the PoW protocol is a fruitchain protocol;
processing transactions includes mining records of committed transactions as fruits, and packaging fruits into a block; and
the respective candidate nodes are identified as having successfully mined a fruit.

7. The method of claim 5, wherein:
the PoW protocol is a Nakamoto protocol;
processing transactions includes mining records of committed transactions as blocks; and
the respective candidate nodes are identified as having successfully mined a block of records.

8. The method of claim 5, wherein the chain of records is stored in a decentralized storage system.

9. The method of claim 1, further comprising establishing, among the new committee of BFT nodes, a private network within the computer network.

10. The method of claim 9, wherein establishing the private network includes broadcasting, among respective BFT nodes in the new committee, encrypted identification information through the computer network, the identification information identifying the respective BFT nodes in the new committee and being protected against access by nodes in the computer network that are not members of the new committee.

11. A non-transitory computer readable storage medium storing one or more programs configured for execution by a computer system, wherein the computer system is configured to execute portions of the one or more programs corresponding to its role in a decentralized computer network, the one or more programs including instructions for:
successfully processing, using a proof-of-work (PoW) protocol, one or more transactions outputted by a threshold number of byzantine fault tolerance BFT nodes in a current BFT committee of the network;
determining that the current BFT committee has outputted a predetermined number of committed transactions; and
in accordance with the determination and the successful processing, advertising a current connection status to the network conveying availability for selection to a new BFT committee.

12. The storage medium of claim 11, wherein the instructions for successfully processing one or more transactions include instructions for using a PoW protocol to add successive records of transactions to a chain of transaction records.

13. The storage medium of claim 12, wherein the PoW protocol is a fruitchain protocol, and the instructions for processing transactions further include instructions for mining records of transactions as fruits, and packaging fruits into blocks in a fruitchain.

14. The storage medium of claim 12, wherein the PoW protocol is a Nakamoto protocol, and the instructions for processing transactions further include instructions for mining records of committed transactions as blocks in a blockchain.

15. The storage medium of claim 12, further comprising instructions for offloading a portion of the chain of transaction records which is stored in a decentralized storage system.

16. The storage medium of claim 11, further comprising instructions for establishing, upon being selected for a new BFT committee, a private network with other BFT nodes within the computer network.

17. The storage medium of claim 16, wherein the instructions for establishing the private network include instructions for broadcasting, among respective BFT nodes in the new committee, encrypted identification information through the computer network, the identification information (i) identifying the computer system as a member of the new BFT committee and (ii) being protected against access by nodes in the computer network that are not members of the new BFT committee.

18. A computer system configured to execute portions of one or more programs corresponding to its role in a decentralized computer network, the one or more programs including instructions for:
successfully processing, using a proof-of-work (PoW) protocol, one or more transactions outputted by a threshold number of byzantine fault tolerance BFT nodes in a current BFT committee of the network;
determining that the current BFT committee has outputted a predetermined number of committed transactions; and
in accordance with the determination and the successful processing, advertising a current connection status to the network conveying availability for selection to a new BFT committee.

19. The computer system of claim 18, wherein the instructions for successfully processing one or more transactions include instructions for using a PoW protocol to add successive records of transactions to a chain of transaction records.

20. The computer system of claim 18, further comprising instructions for establishing, upon being selected for a new BFT committee, a private network with other BFT nodes within the computer network.
